(19) United States
(12) Patent Application Publication
(10) Pub. No.: US 2013/0118043 A1
(43) Pub. Date: May 16, 2013

(54) Assembly for protecting an item against theft including a marking device having a variable display

(71) Applicants: Alain Favier, Nogent Sur Marne (FR); Tamas Lodi, Budapest (HU)

(72) Inventors: Alain Favier, Nogent Sur Marne (FR); Tamas Lodi, Budapest (HU)

(73) Assignee: EXAQTWORLD, Joinville le Pont (FR)

(21) Appl. No.: 13/812,560

(22) PCT Filed: Jul. 27, 2011
(86) PCT No.: PCT/FR2011/051809

§ 371 Date: Jan. 28, 2013

(30) Foreign Application Priority Data
Jul. 27, 2010 (FR) 1056183

(51) Int. Cl. G08B 13/00; G09F 11/04; G09F 11/00; G09F 11/15

(52) U.S. Cl. CPC G08B 13/00; G09F 11/15; G09F 11/04; G09F 11/00
USPC 40/471; 40/446; 40/518; 40/492; 340/572.8

(57) ABSTRACT

An assembly for protecting an item against theft, includes a device (10) for marking the item with a view to identifying same, the device including an area (16) for displaying information, a storage medium (26) in which data to be displayed is stored, elements (22, 24) for selecting data from the storage medium (26) to be displayed in the display area (16), wherein the protection assembly includes a member (14) for attaching the assembly to the item to be protected or to the packaging thereof.

The invention relates to a device for marking an item for the purposes of identifying it. More particularly, the invention relates to a device for protecting an item against theft, notably against shoplifting.

In order effectively to combat shoplifting and, more particularly, the theft of certain products such as textile products (shirts, pullovers, undergarments, pants (trousers), lingerie, ties, socks, t-shirts, dresses, coats, hats, shoes, polo shirts, skirts to name but a few), retailers in the known way use security tags (also known as beepers, clam tags or “EAS tags”). These security tags trigger a walk-through security scanner or a monitoring system of RFID type located at the access point (entrances/exits) of a sales point such as a shop of the superstore or megastore type, a boutique, a specialist shop, a duty free, a department store, a museum, a video club, a pharmacy, or any other shop, store or entity engaging in self-service sale or display of items that are likely to be stolen or abstracted without authorization.

These tags are generally made up of two parts:
a body, which contains a locking system and an active or passive member which triggers the antennas or walk-through detection scanners commonly installed at the access points of the shops or stores,
a pin which passes through the item that is to be protected (for example the fabric of the garment) or alternatively the cardboard or the plastic of the blister pack.

Certain companies offer to print a logo or a particular message on the body or on the pin of the tag. Generally, this printing is performed using tampography. Tampography is an indirect offset (gravure) process using an acid-etch flat steel plate known as the cliché or image plate, and which is filled with ink. A smooth and elastic non-absorbent silicone rubber pad is then used to pick up a coat of ink from the cliché and transfer it onto the substrate that is to be printed.

This process, which is very widespread within industry, is incapable of achieving photographic-quality prints or prints that require multiple colors mixed with one another and overlapping. It is generally restricted to non-complex shapes involving one or two colors (a logo, a trademark, a company name), even though, in theory, a tampography machine can print in five colors or more.

This method creates printed effects which are resistant to mechanical wear but do, however, prove to be fairly costly.

Other printing methods, such as screen printing, are able to achieve very complex prints such as photocopies, multicolored images, etc., but cannot print onto thick rigid supports such as security tags, whether this be onto the pin or onto the body of the tag.

Users of security tags that have been preprinted using tampography or a similar process that prints a monochrome or multicolored image onto the body or on the pin of the security tag are faced with another problem: these users have observed rapid deterioration of the preprinted image because, owing to their lifespan (5 to 10 years), security tags are reused many times in shops and are therefore frequently handled, leading to wear. Specifically, the tags come into contact with the detacher mechanism installed at the pay desk and are then subject to various mechanical rubbings against one another in the tubs in which they are collected before being refitted to other commercial items.

Furthermore, each security tag of the above-mentioned type bears an image representative of a make, of the commercial item itself, of a commercial operation (a promotion, etc.) etc.

Thus, if there is a desire to add additional information relating to the item another tag bearing this information has to be used or the image on the tag has to be modified, although this is not possible because the image is printed actually on the body or the pin.

In general, this problem is also encountered with a device for marking an item for the purposes of identifying it. Such a device does not indeed necessarily have to have a theft-prevention security function.

The invention seeks to remedy at least one of the abovementioned disadvantages by proposing an assembly for protecting an item against theft, characterized in that it comprises a device for marking the item so that it can be identified, the marking device comprising an information viewing zone, a support for information to be viewed, means for selecting information from the support that is to be viewed in the viewing zone, the protection assembly comprising means of attaching said assembly to the item that is to be protected or the packaging thereof.

In will be noted that the protection assembly according to the invention may comprise a single part, namely the marking device equipped with means of attachment to the article such as one or more clamping members such as a clip (to be attached to an item or to packaging which, for example, cannot have a spike passing through it) or two parts, one of which is the abovementioned marking device, the two parts being attached to one another and to the item using means of attachment borne by one part or the other.

The invention thus makes it possible to vary the information that is to be viewed (image(s), photograph(s), drawing(s), text(s) and/or a combination of one of these elements within the viewing zone which is, for example, a display window), by selecting information from the support and by replacing the information already on view with that selected.

Thus, such a marking device associated with a commercial item, for example by attachment thereto, allows the desired commercial information to be put on view to the customers of a shop.

According to one feature, the protection assembly according to the invention comprises a complementary device and means of assembling the two devices with one another and of locking them in the assembled position, the marking device and/or the complementary device comprising the means of attachment to the item or to the packaging thereof.

The two devices are used in conjunction with the item that is to be protected and, for example, grip it in such a way that once they have been assembled and locked together, they cannot be separated from the item.

The only way to remove the protection assembly from the item is then to use a detacher which unlocks the two devices and is installed in the conventional way at the pay desk of the shop or store in which the item is offered for sale.

It will be noted that the means of attachment to the item or to the packaging thereof (for example a spike passing through the item or the packaging thereof) can be arranged on either one out of the marking and complementary devices.

According to an alternative, each of the devices bears part of the means of attachment.

According to one feature, out of the marking device and the complementary device, one is equipped with a spike intended to be introduced into the other device, the latter comprising means of locking the spike to prevent it from being withdrawn so as to lock the protection assembly or to the packaging thereof.

The other device comprises, for example, an orifice for inserting the spike into this other device and the locking means prevent the spike from being withdrawn once it has been inserted.

By way of example, on the marking device information is selected that relates to a particular promotional operation being performed on the item, such as a percentage markdown on the selling price for the item, depending on the desired promotional campaign.

The information support comprises for example a plurality of pieces of information and, in the example chosen, a plurality of different markdown percentages which are selected by shop staff and viewed once the staff have selected them.

A marking device associated with an item may thus display a 20% markdown one day and, through a simple action by shop staff, display a 30% markdown the following day.

The variable-display protection assembly according to the invention means that it is not necessary to change marking device in order to display other information.

It will be noted that the protection assembly according to the invention may potentially comprise means of identifying the assembly and also of identifying the item with which it is combined (by attachment). Such means are, for example, achieved using an RFID chip.

According to one feature, the information support is a support comprising a plurality of printed information regions, the information selection means being able to select one or more information regions to be viewed in the viewing zone, the other information regions being hidden.

Thus, not all of the information borne by the support is visible from outside the assembly, and notably from outside the marking device, the selection means making it possible to view only the desired information.

According to one feature, the marking device comprises an information display window where at least part of the window is transparent and constitutes the information viewing zone so that the selected information region or regions is or are visible through said at least one transparent window part.

This window for example also affords protection (mechanical protection for example against wear, dirt, dust, splashes, moisture, etc.) to the information borne by the support.

It will be noted that insofar as the printed regions of the information support are protected, notably against wear, the material used to make the printing region of the support can be chosen such that it lends itself particularly well to the processes which deliver complex varied print effects, calling for numerous colors, and high quality.

There is therefore no longer any need to be restricted solely to printing techniques in which the printing is wear resistant, for example techniques of the tampography type.

Such protection also means that the life of the inscriptions (text, drawings, etc.) incorporated into the printing regions can be lengthened considerably.

The window thus comprises at least one transparent part through which the selected information can be viewed and may, for example, comprise another part which is opaque in order to hide those information regions of the support that have not been selected.

According to one feature, the support is an elongate strip comprising a plurality of printed information regions arranged side by side in the lengthwise direction of the strip, said strip being wound around two rollers which are spaced apart and each capable of rotating about their longitudinal axis in order to cause information regions of the strip to file past said at least one transparent window part.

Such an arrangement means that the marking device and, therefore, the protection assembly according to the invention, can be rendered particularly compact.

The strip bearing information can thus be likened to a reel of photographic film and used in the cameras of yesteryear.

The information that is to be viewed is selected in a particularly simple way by turning the rollers that support the strip.

According to one feature, the turning of the rollers is brought about by a tool external to the marking device.

Recourse to an external tool safeguards the information selection function and reserves it for shop staff as they alone possess this tool.

For example, the tool is an electric screwdriver which may or may not be fitted with a torque control mechanism.

Thus, the marking device is factory-configured so that, when a predetermined mechanical torque applied to one of the rollers is exceeded, the turning of the roller by the tool no longer causes the strip to file past.

This predetermined torque is thus factory-set to obtain a certain tension in the strip and, once this tension has been achieved, the roller then “idles”.

Incorporating the torque control function into an external tool simplifies the manufacture of the marking device.

According to one feature, the tool is a manual screwdriver, the marking device comprising a torque control mechanism between the tool and one of the rollers to be actuated.

In general, whatever the location of the torque control mechanism, this mechanism has two functions: preventing the information bearing strip or film from tearing as a result of excessive tension and ensuring that the strip is sufficiently tensioned to avoid the formation of unattractive creases.

According to another feature, the marking device comprises:
at least one motor connected to at least one of the rollers by a gearing mechanism,
at least one electrical power supply system,
at least one electrical control system for controlling said at least one motor,
at least one activation information receiver element for controlling said at least one motor.

In this other embodiment, the rollers are turned not by an external tool, but on receiving information transmitted remotely, for example by radio or infrared. This received information activates the motor and therefore causes the information regions of the strip to file past as desired.

The shop staff can thus very easily transmit information by radio or by infrared from a fixed or mobile control station in order to vary the information on view in one or more marking devices which may or may not be present on commercial items within the shop or store.

According to one feature, the support is a disk comprising on one face a plurality of printed information regions arranged side by side over various angular sectors of the face of the disk. The disk or the window is, for example, able to rotate about its center to bring information regions and said at least one transparent window part geometrically into register with one another.

A relative movement of the disk with respect to the display window allows one or more desired information regions to be brought to face a transparent part of the window.

According to another feature, a cover is positioned on top of the disk and provided with an opening positioned facing an information region that is to be viewed.

This open cover in its non-open (opaque/non-transparent) part hides the information that has not been selected.

It will be noted that the opening acts like a display window.

According to one feature, the cover is able to turn about its center so that the opening is brought geometrically into register with an information region that is to be viewed of the disk.

The function of selecting the information to be displayed is thus performed by rotating one of the abovementioned elements.

Information that has not been selected is concealed by the opaque window part or by the non-open part of the cover, as the case may be.

According to an alternative, the window has an overall shape substantially corresponding to that of the disk and comprises, on the one hand, a transparent part in the form of an angular sector for viewing the selected information region or regions and, on the other hand, a non-transparent part hiding the other information regions that have not been selected.

According to another embodiment, the information viewing zone is a digital display screen, the marking device comprising:
at least one power supply system,
at least one display selection system,
at least one activation-information receiver element for selecting the display.

In this embodiment, the digital display screen is, for example, a screen of LCD type and the information support is, for example, in the form of an electronic memory or some other type of information storage.

It will be noted that, in order to select the display, namely what information is to be viewed on this marking device, it is necessary to transmit information (for example an activation signal) to it so that the information that is to be viewed can be transferred from the support (memory, etc.) onto the screen.

According to an alternative, the display selection can be activated by mechanical contact, such as, for example, by using a knob or pushbutton of the type used on certain watches.

According to one feature, the marking device comprises a spike extending out from it and collaborating with the complementary device so that the two devices can be assembled and locked together.

The spike constitutes a means of attachment to the item that is to be protected and which passes through this item or the packaging thereof before collaborating with the complementary device.

According to one feature, the marking device comprises a casing forming an open housing to accommodate the information support, the display window being positioned on the casing in such a way as to close the housing.

This arrangement is a particularly simple design concept.

According to an alternative, the marking device comprises locking means for locking a spike that is intended to be introduced into the casing.

The spike is generally borne by a complementary device and introducing the spike into the casing allows the two devices to be assembled together in the locked position.

The spike locking means prevent this spike from being withdrawn once it has been inserted. It will be noted that the abovementioned features of the marking device also apply when the spike is borne by the complementary device rather than by the marking device.

According to one feature, the spike of the marking device extends out from the casing in the direction away from the window.

The spike is thus intended to be inserted into a complementary device so that the two devices can be assembled.

According to one feature, the marking device and/or the complementary device comprises at least one active or passive member which is able to emit electromagnetic waves to outside the device or to receive such waves, thus affording a function of protecting the item against theft. It will be noted that this feature applies irrespective of which device bears the spike of the means of attachment to the item and of assembling the two devices and locking them together.

Thus, the member or members which are able to collaborate with a complementary theft detection system (example: walk-through security scanner) and of triggering an alarm are housed in at least one of the two devices.

The member borne by this or these devices is, for example, a passive member which receives electromagnetic waves when situated in close proximity to the complementary detection system.

Such a passive member is, for example, a resonant electric circuit which goes into resonance, in the known way, under the action of excitation waves emitted at the resonant frequency of the circuit.

The member or the members liable to corporate with a complementary theft detection system and to trigger an alarm are, as an alternative, one or more active members emitting electromagnetic waves in response to, or not in response to, electromagnetic waves received from the complementary system.

According to one embodiment, the window is arranged via one of its faces referred to as the internal face facing a face referred to as the internal face of the information support bearing the information regions, a spike attached to the window extending from the internal face of said window toward the internal face of the support and passing through the latter so that it protrudes to the outside with respect to a face referred to as the external face of the support.

According to another embodiment, the marking device comprises a head having two opposite faces, an internal face and an external face from which the spike extends, the information support being positioned between the internal face of the head and the display window.

In the general configuration of the invention (information viewing zone, information support, information selection means and means of attachment), the means of attachment to the item may adopt the form of members that clamp the item (without penetrating through it), for example a clip, which can be actuated to make them grip/release the item by a control member. The clamping members and the control member form part of the protection assembly and, for example, of the marking device, and are not separate components.

Another subject of the invention is an item, for example commercial item, fitted with an assembly protecting it against theft (the assembly is attached to the item) as briefly explained hereinabove and which comprises at least one of the features set out hereinabove.

Other features and advantages will become apparent during the course of the description which follows, given solely by way of nonlimiting example and made with reference to the attached drawings, in which:

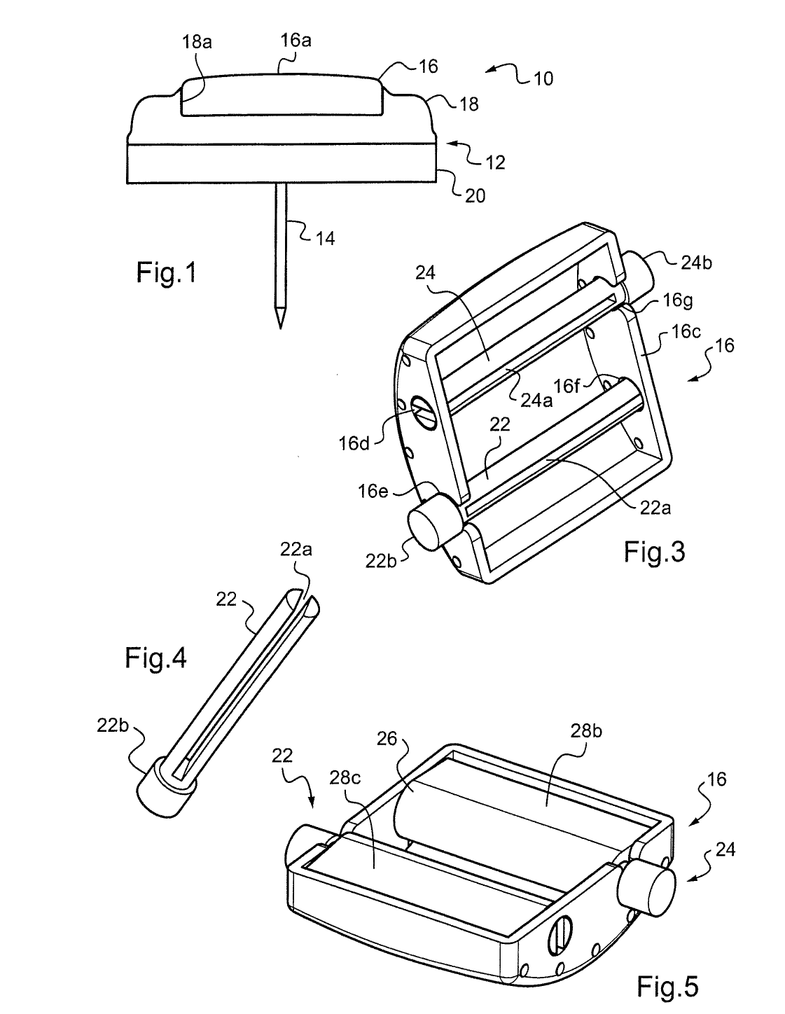

FIG. 1 is a schematic view in the assembled position of a marking device of a protection assembly according to a first embodiment of the invention;

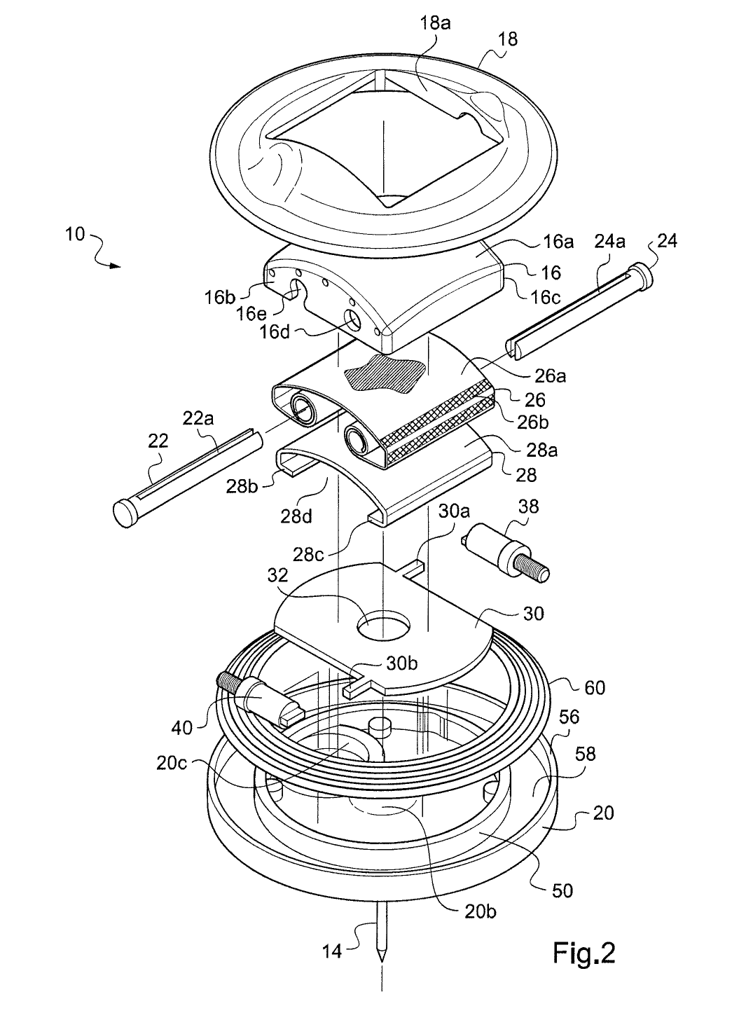

FIG. 2 is an exploded perspective view of the device of FIG. 1;

FIG. 3 is a perspective view from beneath of a cap incorporating two rollers;

FIG. 4 is a perspective view of one of the rollers of FIG. 3;

FIG. 5 is a perspective view from beneath of the cap of FIG. 3 incorporating an information support and its bearer;

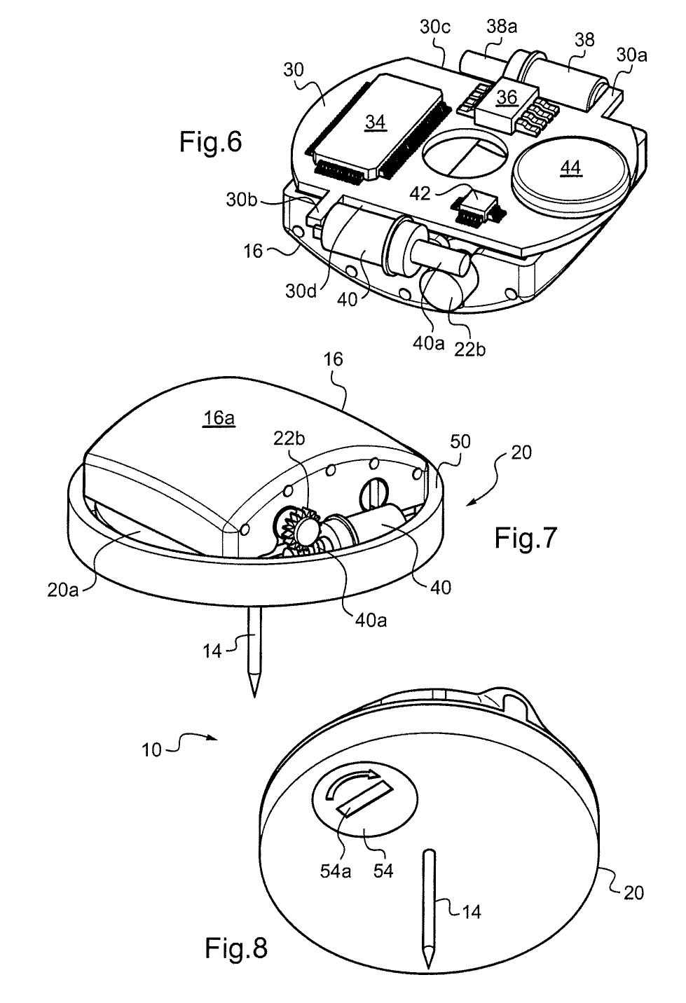

FIG. 6 is a view from beneath showing part of the internal elements of the marking device of FIG. 2, in the assembled position;

FIG. 7 is a partial schematic view showing the collaboration of a motor with one of the rollers incorporated into the cap of FIGS. 3 and 5;

FIG. 8 is a perspective view from beneath of the assembled device;

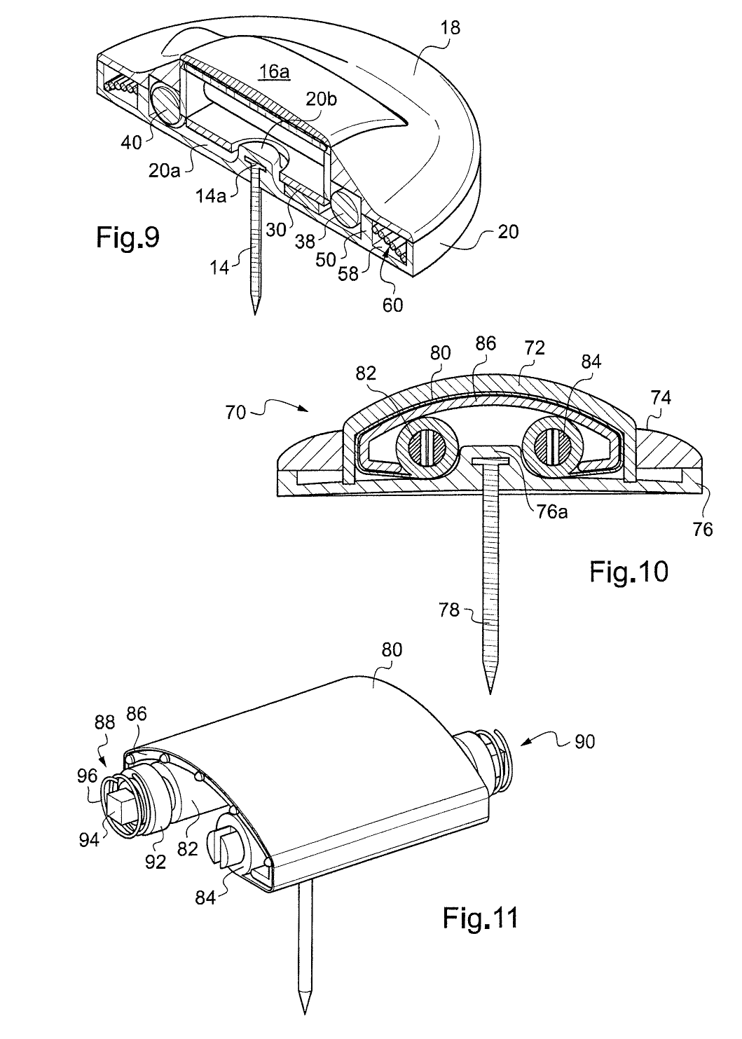

FIG. 9 is a schematic perspective view of an axial section through the marking device of FIGS. 1 to 8;

FIG. 10 is a schematic view in axial section of a marking device of a protection assembly according to a second embodiment;

FIGS. 11 to 13 depict various schematic views of assemblies that can be used to turn the rollers in the absence of a motor,

FIG. 14 is a schematic overview showing the use of a tool 120 to alter the display of the marking device 70;

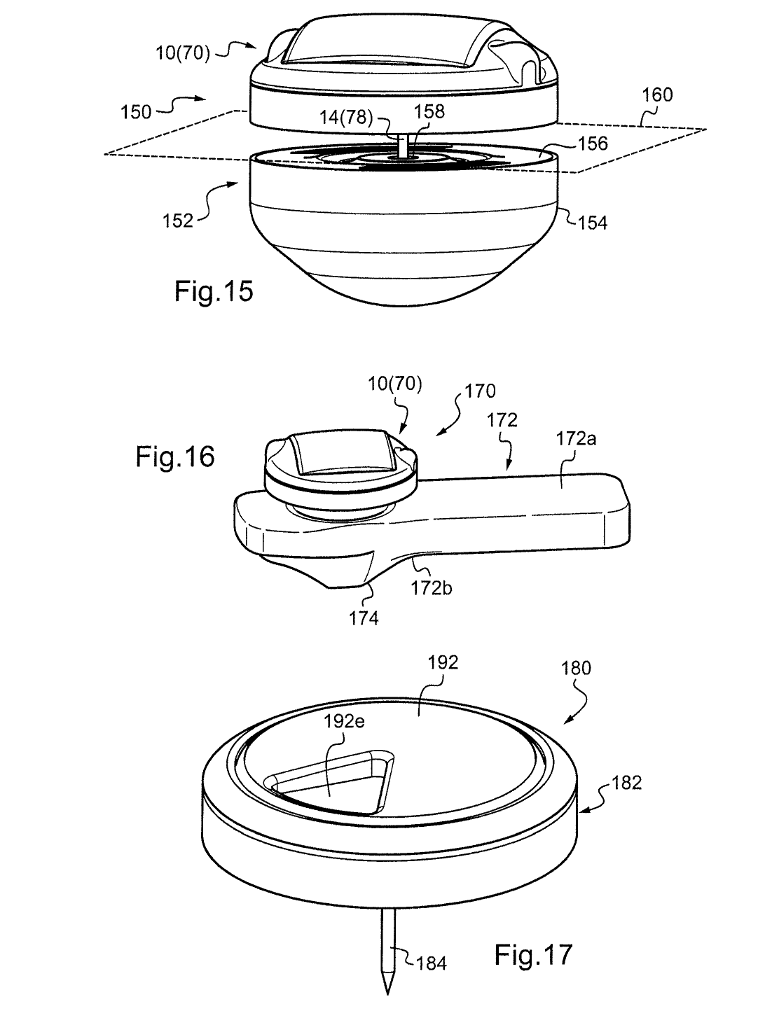

FIGS. 15 to 16 depict two examples of assemblies for protecting an item against theft incorporating a marking device according to one or other of the abovementioned embodiments;

FIG. 17 is a schematic perspective overview of a marking device of a protection assembly in the assembled position according to a third embodiment of the invention;

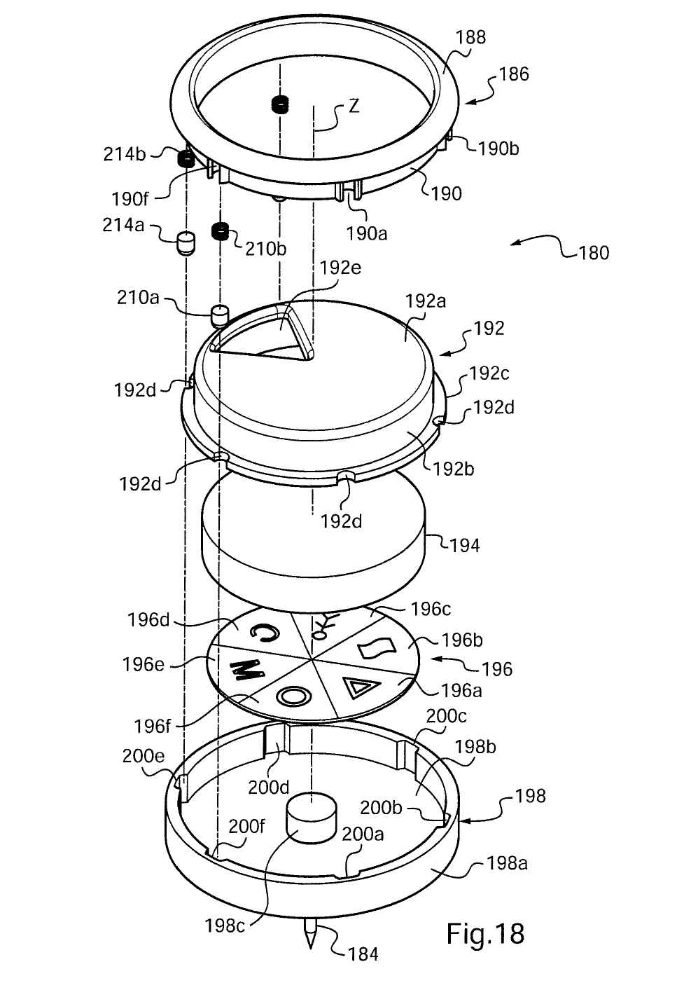

FIG. 18 is an exploded perspective view of the device of FIG. 17;

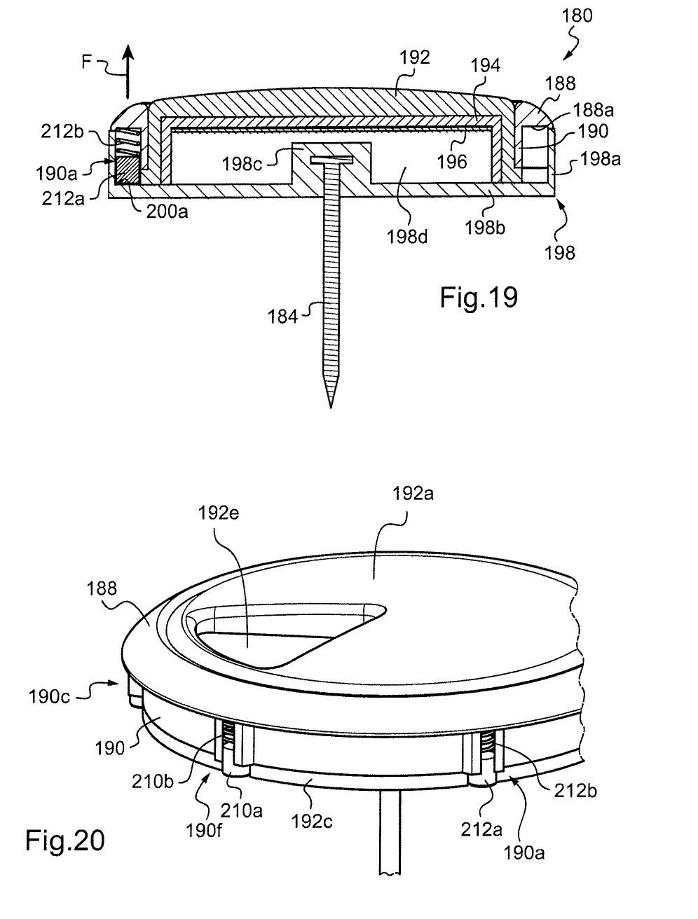

FIG. 19 is a schematic view in axial section of the device of FIGS. 17 and 18;

FIG. 20 is a partial schematic view illustrating the mechanism that prevents the display window from turning;

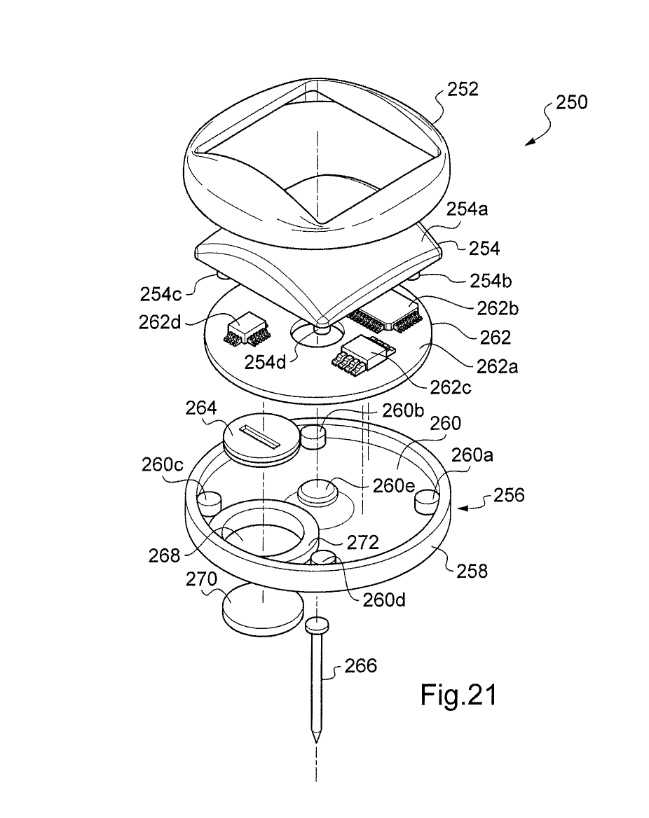

FIG. 21 is an exploded perspective view of a marking device of a protection assembly according to a fourth embodiment of the invention.

As depicted in FIG. 1 and denoted overall by the reference 10, a marking device of an assembly for protecting an item, for example a commercial item, against theft according to the invention comprises a head or casing 12 and a spike 14 which extends out from the casing away from the latter.

The casing 12 also comprises a transparent cap or window 16 snugly fitted into a peripheral surround 18 which has a central opening 18a to accept the transparent cap 16.

The surround or frame 18 is mounted on a base 20 and is fixed to the latter by conventional mechanical means.

The spike 14 projects from the external face of the base and is, for example, attached to the interior thereof.

FIG. 2 is an exploded view of the device of FIG. 1. The device thus comprises, starting from the top, the peripheral surround or frame 18 with its central opening 18a, for example of square shape (the shape could equally well be rectangular or even round or ovoid), to house the transparent cap 16 the periphery of which is of a complementary shape so that it can be fitted into the opening 18a.

This cap acts as an information viewing zone.

The cap has an upper surface of convex shape 16a and comprises two opposite lateral faces 16b and 16c each provided with two openings. The convex or dome shape of the cap means that the device can be made more compact.

In FIG. 2, only the openings on the face 16b have been depicted.

One of the openings 16d is in the shape of a complete circle whereas the other opening 16e is of semicircular shape, open along one of its sides in order to accept one of the two rollers 22, 24 depicted in FIG. 2.

FIG. 3 is a perspective view of the cap 16 from beneath and reveals the second lateral face 16c with a complete circular opening 16f and a semicircular opening open on one of its sides 16g.

Thus, the rollers 22 and 24 can be introduced into the cap 16 through the openings 16e and 16g.

Each of these rollers is provided with a longitudinal slot 22a, 24a respectively, passing right through the substantially cylindrical roller over practically the entire height thereof, thus forming two half-cylinders.

Each roller is also equipped with a respective head 22b, 24b projecting outside the cap 16.

FIG. 4 illustrates the longitudinal slot 22a of the roller and the head 22b thereof.

Returning to FIG. 2, the device 10 also comprises a support for information to be viewed, which support is created for example in the form of an elongate strip or film of paper or some other material and which comprises a plurality of printed information regions arranged side by side in the lengthwise direction of the strip.

In FIG. 2, two information regions 26a and 26b are positioned side by side.

At each of its opposite ends the strip 26 is inserted into one of the slots 22a, 24a in each roller, and is then wound around the roller in order to adopt a position like that depicted in FIG. 2.

In this position, the information support 26 is wound around the two rollers 22 and 24 which are parallel to one another and spaced apart.

Each of the rollers is able to turn about its longitudinal axis in order to cause information regions of the strip 26 to file past the transparent cap 16 and, more particularly, the transparent upper face 16a (display window).

It will thus be appreciated that each of the rollers forms selection means allowing information on the support 26 to be selected for viewing in the viewing zone (upper face 16a of the transparent cap).

The strip moves in one direction (forward) or in the opposite direction (backward) depending on which of the two rollers is turned.

It will be noted that when one or more pieces of information located in an information region is or are viewed through the transparent window 16a, the other information regions of the support are hidden from the outside and are therefore not visible.

The device 10 comprises a bearer 28 having a domed overall shape in its upper part 28a and having two returns 28b and 28c partially including the bearer at its lower part, leaving an opening 28d between the returns.

The information support 26 arranged around the rollers 22 and 24 thus positions itself on the bearer 28 and is wrapped around the returns 28b and 28c so that the ends of the strip 26 which is wound around the rollers 22 and 24 are positioned inside the bearer 28, via the opening 28d.

Once these elements have been assembled, the assembly formed of the support 26 mounted on the rollers 22 and 24 and enveloping the rigid bearer 28 is installed in the cap 16 as depicted in FIG. 5.

The marking device 10 comprises a plate 30 positioned underneath the information support (FIG. 2).

The plate 30 has a central opening 32 and two lugs 30a and 30b.

The plate has dimensions corresponding to the size of the display window 16a.

As depicted in FIG. 6, the underside of the plate 30 (not visible in FIG. 2) bears the electronic components 34, 36 which form an electrical/electronic control system for controlling two motors 38 and 40. These components are, for example, programmable components of FPGA type, or may be preprogrammed circuits such as circuits of the ASIC type.

Alternatively, these components may comprise a microprocessor and one or more memories for storing data and miscellaneous information.

Another component 42, also attached to the plate 30, is a receiver element for receiving information communicated to the device 10 remotely, for example via radio waves or using infrared.

This element is thus a receiver suited to receiving information transmitted by one of these communication means or by another communication means not already described.

The information received by the component 42 from outside activates one and/or the other of the motors 38 and 40 depending on the information.

As depicted in FIG. 6, very schematically, and more specifically in FIG. 7, each of the motors 38 and 40 is positioned along one of the edges of the plate 30. The two motors are thus mounted top to tail parallel to one another along two opposite sides 30c and 30d of the plate 30.

Each motor is arranged by one of its ends against one of the lugs 30a, 30b, which thus acts as an end stop for it.

Each motor at its opposite end comprises an output shaft 38a, 40a respectively, which is threaded so as to mesh with the head of one of the two corresponding rollers 22, 24 which head is fitted with a pinion (FIG. 7).

Thus, each motor is connected to a roller by a gearing mechanism and the reception by the circuit or component of information to activate a motor allows the threaded axle emerging from the corresponding motor to be turned and thus because it is in mesh with the pinion of the corresponding roller, turns this roller.

The turning of one of the rollers therefore causes the strip 26 (information support) to move, and this makes the printed images or information file past the display window 16a.

Which of the two motors 38, 40 is activated is dependent on the information received from outside, causing the strip 26 to file past in one direction or the other.

Thus, the strip can be wound onto or unwound from one of the rollers 22 and 24.

It will be noted that, for the sake of clarity, the various electrical connections between the components with which the plate 30 is equipped have not been depicted here.

The element 44 attached to the plate 30 (for example inserted in an open cylindrical housing secured to the plate and not depicted in the figure) represents a system for electrically powering the various electrical/electronic circuits and components arranged on this plate.

The element 44 is, for example, an electric battery cell.

This element 44 thus supplies electrical power needed for selecting which information on the support is to be viewed through the transparent window of the cap 16 (display window).

As depicted in FIG. 2, the marking device of a protection assembly according to the invention comprises the base 20 a central part of which is hollowed out and delimited by a first internal rim 50.

The cap 16 containing the information support 26 and the bearer 28 and which is mounted on the plate 30 is arranged in the central part 20a of the base, as are the motors 38 and 40.

It will be noted that the periphery of the cap 16 is of substantially square shape this shape being suitable for the cap, once housed inside the central part 20a of the base, to create between each of its lateral faces and the internal edge 50 of the base a space in which a motor and the head of one of the rollers can be accommodated.

The hollowed-out central part 20a at its center comprises a projecting zone 20b in which the head 14a of the spike 14 is housed (FIG. 9).

This projecting zone 20b penetrates the opening 32 of the plate 30 when this plate is installed fully into the housing delimited by the rim 50.

It will be noted that the lugs 30a and 30b of the plate collaborate respectively with slots made in the rim 50 so as to prevent the plate from turning.

As depicted in FIG. 2, the central part 20a of the base also has a projecting zone 20c which is eccentric in relation to the central zone 20b and which is provided with a through-opening in which the battery cell 44 FIG. 6 can be housed.

Moreover, as depicted in FIG. 8, a cover 54 closes the through-opening 20c which, normally in the absence of a cover, opens onto the underside of the base 20.

This cover 54 is provided with a notch 54a allowing this cover to be turned so that the battery cell 44 can be replaced if need be.

The base 20 also comprises an external rim 56 which together with the internal rim 50 defines an annular space 58 surrounding the central zone 20a (FIGS. 2 and 9).

This annular space houses one or more passive members 60 which are able to receive from outside the device electromagnetic waves originating from a security/detection (antitheft) system of which the protection assembly comprising the device forms part.

Thus, when an item sold in a shop or store and to which the device 10 is attached by the means of attachment 14 comes into proximity of an emitter of electromagnetic waves, the passive member 60 receives these waves, thus triggering an alarm.

For example, the passive member or circuit 60 is, for example, a resonant circuit which, when subjected to electromagnetic waves, goes into resonance and thus triggers an alarm system as it passes a walk-through security scanner containing the emitter. This walk-through security scanner is installed at a point of sale (shop or store) of the item that is to be protected or in a room in which the item is on display.

It will be noted that the space 58 reserved in the base 20 allows the active or passive members of the marking device to be offset in relation to the location at which the motors and the electronic controls controlling these motors are located.

Offsetting the active or passive circuits or members means that the presence of the motors does not disturb the detection of the device as it is moved past a walk-through security scanner in a shop or store.

Alternatively, when there is no motor in the marking device, the active or passive detection members or circuits may be arranged at some other point in the device. The device can thus be more compact.

FIG. 10 illustrates a marking device of an assembly for protecting an item against theft according to a second embodiment of the invention.

This device 70 resembles the device of the first embodiment in that it comprises a transparent cap 72 fitted snugly into a peripheral surround 74 and mounted on a base 76.

Just like the device of FIG. 1, the parts 74 and 76 of the casing or head are attached to one another and, as an alternative, could be produced as one single piece.

Likewise, the part that forms the surround 74 also serves to hold the cap or window 72 in position as in FIG. 2.

The means of attaching the device to an item are also embodied by a spike 78 which extends from the underside of the base 76.

More specifically, this spike is fixed in a raised central part 76a of the base.

Just like the device in FIG. 2, the cap 72 contains the assembly formed of a support of information to be viewed 80 wound around rollers 82 and 84 and mounted on a bearer 86 so as to envelop same.

The way in which these elements are arranged is the same as that described with reference to FIG. 2.

However, in this embodiment the plate 30 and the motors do not exist. The assembly contained inside the internal cavity of the cap 72 rests on the internal face of the base 76, in the hollowed-out central zone thereof and, more particularly, around the raised zone 76a.

The cap 72 is also arranged bearing against or even attached to the internal face of the base 76.

The device 70 may be even more compact than the device of FIG. 2 because of the elements absent from it.

Here, it is an external tool that is used to select which of the information borne by the information support 80 is to be viewed in the viewing zone 72 (display window).

FIG. 11 depicts the assembly formed of the information support 80 mounted both on the rollers 82 and 84 and on the bearer 86.

Each roller 82, 84 is equipped at its head with an assembly 88, 90 with which an external tool can collaborate in order to select which information to view.

When seen from the outside (FIG. 11), each assembly comprises the same elements.

The assembly 88 comprises a ring-forming element 92 equipped on its external surface with a tenon-shaped element 94 around which a spring (a spiral spring) 96 is arranged.

This spring bears at one of its ends against the external face of the ring 92.

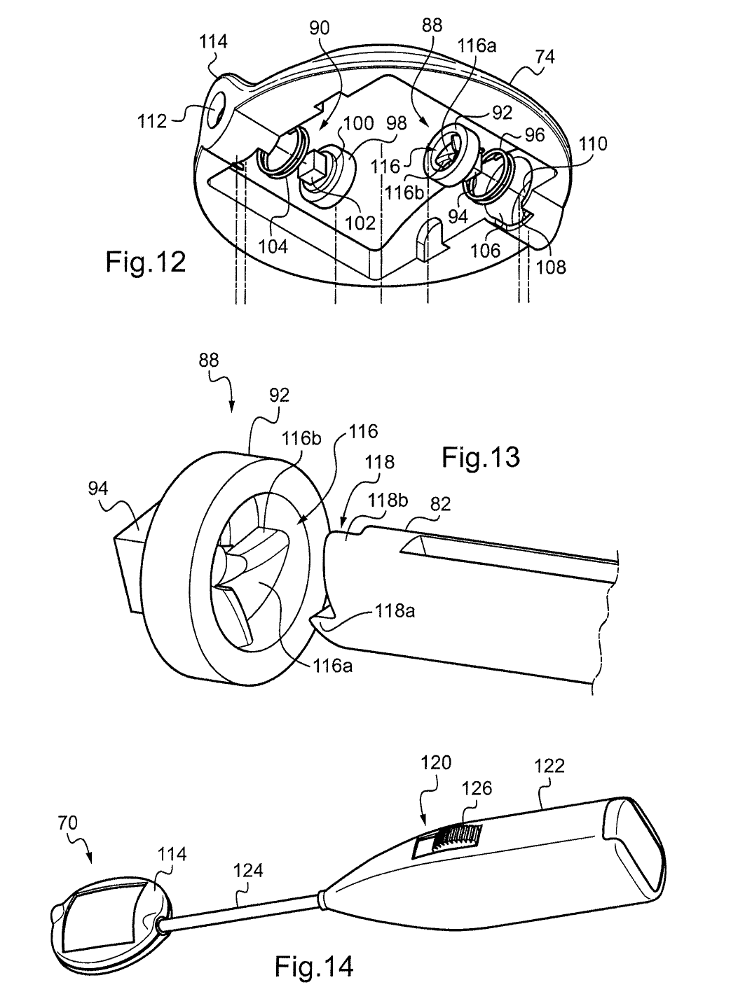

FIG. 12 depicts a view of the peripheral frame 74 and of the assemblies 88 and 90 from beneath. A raised-up part 100 forming a shoulder and to which the tenon 102 is fixed is depicted on the external face of the ring 98 of the assembly 90.

This shoulder thus allows the spring 104 to be held in position.

As depicted in FIG. 12, the assembly 88 is inserted into a substantially circular hole 106 made in the peripheral frame 74.

Likewise, another hole is made in the frame 74 on the opposite side, to accommodate the assembly 90.

The hole 106 has an opening 108 of a cross section that is smaller by comparison with the diameter of the hole.

A peripheral zone forming a collar 110 is provided around the opening and one of the ends of the spring 96 bears against this zone when the assembly 88 is inserted into the hole 106.

A circular opening 110 is depicted on the opposite side, and aligned with the tenon 102.

When viewed from the outside, the frame 74 thus comprises two bosses or projecting parts in which the respective assemblies 88 and 90 are housed. Just one boss 114 is visible in FIG. 12 and accommodates the assembly 90.

It will be noted that each ring 92, 98 comprises, on the opposite side to the side on which the tenon 94, 102 is located, a hollowed-out interior zone in the end of which there is toothed system comprising a plurality of teeth arranged in a circle.

The toothed system 116 (FIG. 13) of the assembly 98 comprises a plurality of teeth each having a ramp 116a and a straight stop wall 116b.

The roller 82 at its free end bears a toothed system 118 of complementary shape, equipped with teeth, for example 118a, 118b, which are intended to mesh with the teeth located opposite and belonging to the system 116. As depicted in FIG. 11, the assemblies 88 and 90 are held in position against the end of the corresponding rollers 84 and 82 by compression springs.

FIG. 14 is a simplified schematic depiction of an external tool 120 comprising a body 122 containing an electric motor and a control circuit for the motor and a shank 124 emerging from the body 122 and able to rotate on itself under the action of the motor.

This tool forms a kind of electric screwdriver.

The free end of the tool, not visible in the figure, has a shape that complements the shape with which the assemblies 88 and 90 are equipped and thus, for example, adopts the shape of a mortise.

When the shank 124 of the tool 120 is inserted into one of the bosses of the frame 74, for example the boss 114, the end of the tool is inserted into the opening 112 and fits around the tenon 102 of complementary shape.

Thus, when the user operates the control button/switch 126, he causes the shank 124 to turn and thereby causes the assembly 90 and therefore the associated roller 84 to turn.

Thus, by causing the roller to turn, the information that is to be viewed (printed zone(s), (image(s), text(s), logo(s), etc.) through the display window of the device can be selected. The tool 120 is, for example, configured so that each time the button 126 is pressed, the rotation of the shank causes the transition from one information region (example: image) to another.

By actuating one of the rollers or the other it is possible to make the information support file past in one direction or the other in order to display the desired information region.

It will be noted that a torque control mechanism is provided between the tool and each roller that is to be actuated.

This mechanism is embodied by systems of complementary teeth with which the rings and the free ends of the rollers are equipped.

According to an alternative, the electric screwdriver could itself be fitted with a torque control mechanism.

Whatever the mechanism or its location, its purpose is to prevent the rollers from turning when an excessive rotation force is applied to them.

This is notably the case when the support (strip of paper or some other material such as plastic) is almost fully unwound from one of the rollers.

This mechanism makes it possible, for example, to control the tension in the strip in order to prevent either tearing, or creasing (unattractive).

FIGS. 15 and 16 illustrate two different types of assembly for protecting an item against theft.

Each assembly comprises a device for marking the item according to the invention.

Each of the devices is, for example, the device 10 or 70 of the preceding figures, or even some other device.

It will be noted that the devices of FIG. 17 et seq. also form part of an assembly for protecting an item against theft.

The protection assembly 150 thus comprises a marking device such as this and a complementary device 152.

This complementary device comprises a body 154 of substantially hemispherical shape and having a substantially planar face 156 situated in an equatorial plane.

An opening 158 is made in the face 156 to allow the insertion of a spike 14 or 78 depending on the marking device.

The body 154, in the known way, contains means for locking the spike once the latter has been introduced into the body.

An item, for example a commercial item 160, for example a garment (only part of the garment has been depicted) through which the spike (means of attachment to the item) of the marking device has passed before this spike is assembled with its complementary device 152 has been depicted schematically in dotted line.

FIG. 16 illustrates another type of assembly for protecting an item against theft (170), in which assembly the marking device is identical to the previous device but in which the complementary device 172 is different.

Specifically, this device takes the form of a thick plate which is substantially planar on one of its faces 172a and has a protrusion 174 on the opposite face 172b.

The upper face 172a is equipped with an orifice for the insertion of the spike of the marking device and the collaboration between the two parts of the two constituent devices of the protection assembly is the same as was described earlier.

According to an undepicted alternative form, the complementary device of FIG. 15 or 16 comprises one or more active or passive members able to emit or to receive electromagnetic waves to the outside of the device or receive such waves, thus collaborating with an external system such as a walk-through security scanner in a premises (point of sale, museum, etc.) so as to detect the presence of the protection assembly in the vicinity of the external system. The member or members is or are for example a member such as the member 60 of FIGS. 2 and 9 and the operation here is identical to that which was described with reference to those figures. It will be noted that several active or passive members can be distributed across the two devices in another alternative form, not depicted, for the purpose of increasing detection reliability (e.g., should one member fail).

FIG. 17 illustrates another embodiment of a marking device of an assembly for protecting an item against theft according to the invention.

The device 180 is depicted in the assembled position in the form of a casing or of a head 182 which is provided with a spike 184 extending out of the casing.

The casing forms an open housing to accept a support for information to be viewed, as detailed in the following figures, and an element comprising a zone for viewing information on the support and which is arranged on the casing in such a way as to close the housing.

FIG. 18 depicts an exploded perspective view of the device 180.

The device thus comprises, starting from the top, an annular ring 186 pierced in its central part, comprising a collar 188 that forms a radially extending rim and an axially extending skirt 190.

The device also comprises a hood or cover 192 having an upper frontal wall 192a, an axial wall of annular shape 192b extending axially substantially perpendicular with respect to the frontal wall 192a.

The wall 192b is equipped, at its opposite free end to the end which is in contact with the wall 190a, with a collar or rim 192c which extends radially toward the outside of the cover or hood 192. The collar comprises a plurality of notches 192d which are open toward the outside.

Moreover, the frontal wall 192a is equipped with an opening 192e which, for example here, has the form of an angular sector.

It will be noted that the opening 192e acts as a display window within the meaning of the invention.

The device 190 also comprises a transparent element 194 acting as a dial face or glass.

This element has the shape of a cylindrical cup closed at one end, open at the opposite end, and positioned in an inverted position in FIG. 18.

The shape and dimensions of this element 194 are suited to it being inserted inside the cover 192.

The device 180 comprises a support 196 for information to be viewed (example: disk) bearing, on one face (the upper face visible in FIG. 18), a plurality of printed information regions (images, photographs, texts, logos, etc) 196a-d which are arranged side by side in different angular sectors of the face of the disk. Each region is, for example, in the shape of angular sector.

However, the opening 192e and the information regions may adopt other shapes.

This disk has dimensions that allow it to be inserted into the open housing formed in the element 194.

As will be seen hereinbelow, in the embodiment described the cover 192 is able to turn about its center embodied on a longitudinal axis Z so that the opening or window 192e can be positioned geometrically in register with one of the information regions of the disk 196. This arrangement thus allows information from the region thus selected to be viewed through this opening (information viewing zone).

According to an alternative that has not been depicted, the glass or dial face 192 may be omitted and the cover 192 is modified so that the opening 192e is closed and made of a transparent material. The rest of the frontal wall 192a is made from a material that is opaque or, at the very least, not transparent.

Thus, the information zones are protected by the cover or lid and the information that is to be viewed is still selected by turning the cover.

The device 180 also comprises a base 198 having the overall shape of a cup open at its upper part and comprising a cylindrical wall 198a extending perpendicular to a bottom wall 198b. The bottom wall, in its central part, has a portion that is raised up in relation to the bottom wall.

This raised-up portion 198c is able to house the head of the spike 184.

The information support 196 can be positioned on this portion 198c or can be fixed to the lower face of the transparent dial face 194, as depicted in FIG. 19 (axial section through the device).

This figure shows the various elements that have just been described assembled with one another the dial face thus containing the support 196 and the dial face itself being inserted inside the cap 192.

An annular housing 198d is present inside the base and the dial face in order, for example, therein to house an active or passive member capable of emitting or receiving electromagnetic waves originating from a complementary security/detection system external to the device 180.

The base 198 on the internal face of its cylindrical wall 198a comprises a plurality of evenly spaced axial slots 200 a-f.

The number of these slots corresponds to the number of information regions borne by the support 196.

Likewise, the number of notches 192d corresponds to the number of information regions.

Moreover, the axial extension 190 of the ring 186 has, on its exterior face, a series of axial housings 190 a-f evenly distributed at the periphery of the skirt 190 and which are partially open thanks to the presence of an axial slit (FIG. 20). The number of housings (for example 6) corresponds to the number of information zones or regions.

The shape of this housing corresponds for example to a half-cylinder forming an outgrowth on the external face of the skirt 190 and open axially.

These assembly members have been depicted in FIGS. 19 and 20 in the assembled position inside the aforementioned respective housings and in FIG. 18 in their position prior to assembly.

The vertical strokes in FIG. 18 show the various elements collaborating with these assembly members being geometrically to register.

Thus, these assembly members consist of pairs each made up, on the one hand, of a peg, for example the pegs 210a, 212a, 214a and, on the other hand, of an elastic element, for example a spring such as 210b, 212b and 214b.

Under the action of the elastic compression element, the pegs are kept partially in position situated at the outside of the housing (for example outside the housing 190f in the case of the peg 210a) and thus become inserted in the notches 192d provided for that purpose on the exterior part of the cover 192.

These assembly members arranged partially inside their housing are inserted into the slots provided geometrically in register inside the base 198.

FIG. 19 depicts a pair of assembly members inside the slot 200a.

It will be noted that the elastic elements bear firstly against the peg and secondly against the underside 188a of the collar 188.

With such an arrangement, the cover 192 is prevented from turning.

Thus, an unintended user wishing to alter the display of the device 180 will be unable to do so.

If there is a desire to alter the display and therefore select another information region of the support 196 an authorized user, such as shop staff in the shop or store in which the item to which such a device is fixed is sold, can succeed in doing so. To do this, he brings over the device a magnet that is powerful enough to attract each of the pegs (210a, 212a, 214a, etc.) vertically upward (in the direction of the arrow F in FIG. 19), thereby compressing the elastic element arranged above the peg enough that the peg fully enters the corresponding housing and therefore leaves the corresponding notch 192d in the cover.

It is then possible for this cover to be turned by hand to bring the display window 192e geometrically into register with the desired information region.

FIG. 21 illustrates another embodiment of a marking device of an assembly for protecting an item or product against theft, according to the invention.

The device 250 comprises a peripheral surround or frame 252 having a central opening of substantially square shape passing right through the frame. This opening is intended to accept an information support 254 of a shape that substantially complements it and which has a convex upper face 254a facing toward the outside of the device.

This information support for example takes the form of a digital display screen (for example of LCD type).

This support is equipped with four legs of which only three, 254b, 254c, 254d, are depicted in the figure.

As depicted in FIG. 21, a base 256 in the form of a cup open at the top comprises an annular axial wall 258 and a bottom wall 260, and a number of pads 260 a-d the number of which corresponds to the number of legs of the information support 254 and which are, for example, arranged at the corners of a square.

These pads are used to position the support and, for example, also, to attach it to the base.

Moreover, the device 250 also comprises a plate 262 arranged between the support 254 and the base 256 and one of its faces, for example the upper face 262a, has various elements: a system for selecting the display of information to be viewed on the screen 254 and an element that receives information transmitted remotely from outside the device, this control information being used to activate the selection for the display of the said information.

More specifically, the face 262a bears various electronic components 262b, 262c which may be application-specific integrated circuits (ASICs), microprocessors and memories, or programmable components of FPGA type for example.

The plate 262 for example has the overall shape of a disk in this example and also comprises an element 262d the function of which is to receive activation information from outside the device 250. This information is transmitted remotely, for example by radio or using infrared or alternatively using some other communication medium, from an emitter base or station.

From this emitter base or station a user can command the change in display of one or more marking devices according to the invention and, in order to do so, transmit activation information to this or these devices with a view to selecting certain information to be displayed selectively on one or more devices.

The activation information received by the element 260d (optical sensor or radio receiver, etc.) is sent to the components 262b, 262c (for the sake of clarity, the electrical connections have not been depicted in the figure) and are then analyzed and processed in one of these components or another. The latter therefore then commands the displaying on the screen 254, by extracting from a zone of a memory space information for viewing which is stored therein and supplying this information to the screen so that it can display it.

The activation information received from outside may vary in its complexity.

Thus, for example, this information may consist only of an activation signal which triggers the displaying of the next items of information from a list of information to be displayed.

Alternatively, this information may be more complex and, for example, include the type of information to be selected with a view to displaying said information, possibly a memory storage address, etc.

A battery or battery cell 264 is provided by way of an electrical power supply system for the aforementioned various electrical circuits and components.

This cell comes into contact with the underside face of the disk 262, which is the opposite side to the face 262a, with electrical contacts and tracks allowing the necessary power to be supplied to the various components.

The base 256 also comprises, in the bottom wall 260 firstly a raised-up central portion 260e intended to accommodate the head of a spike 266 used for attaching the device 250 to a commercial item that is to be protected and, secondly, a through-opening 268 made in the bottom wall 260.

This through-opening opens onto the underside of the base 256 and in its internal part has a threaded portion so that a cover 270 that closes this opening can be screwed in/unscrewed.

The opening 268 is bordered by an annular ring 272 inside which the battery cell 264 is housed.

It will be noted that the various marking devices that have been described all have a spike by way of means of attaching the device to an item or product, for example a commercial item or product (or the packaging containing the item) that is to be protected against theft.

However, such a means of attachment (spike) may be provided in the complementary device with which the marking device collaborates in order to form an assembly for protecting an item against theft.

In such a case, the means of attachment to the item with which the device is to be associated are borne by the complementary device.

Furthermore, when the marking device according to the invention is associated with a complementary device, either one and/or the other of these devices comprises one or more active or passive members capable of emitting or of receiving electromagnetic waves originating from a source external to the device.

Once again, there are various possible ways in which the two devices can be arranged relative to one another, combined with the presence of the means of attachment in either one of these devices or the other.

According to alternative form that has not been depicted, the assembly for protecting an item against theft comprising a marking device according to the invention comprises other types of means of attachment to an item that is to be protected and which do not entail piercing the item or the packaging containing same (for example, shoes, spectacles or even items or packagings which are made of materials that are too hard or too fragile to be able to be pierced by a spike).

These may, for example, be gripping/ungripping members, for example produced in the form of a clip, the two jaws of which can be moved closer together or further apart under the action of a control member arranged on the marking device.

Thus, the device of the protection assembly constitutes a single piece which bears all the elements needed for attachment to the item or to the packaging containing the item to be protected against theft.

The control member may for example be a knob or a button that is turned in order to move the clamping members by moving one closer toward or further away from the other depending on the movement desired. An internal mechanism connects the control member to the clamping members.

Such members are described in international application PCT/FR2010/050400 filed on Mar. 9, 2010.

According to yet another alternative form that has not been depicted, when the means of attaching the marking device of an assembly for protecting an item are embodied in the form of a spike, this spike may penetrate further into the device that has been depicted in FIGS. 1 to 21. Thus, it is possible that the spike is fixed no longer to the base of the device but to one of the elements arranged on top of the base, such as the information display window for example, or even an intermediate element somewhere between that and the base.

1. An assembly for protecting an item against theft, characterized in that it includes a device for marking the item so that it can be identified, the marking device including an information viewing zone, a support for information to be viewed, means for selecting information from the support that is to be viewed in the viewing zone, the protection assembly including means of attaching the assembly to the item that is to be protected or the packaging thereof.

2. The protection assembly as claimed in claim 1, characterized in that it includes a complementary device and means of assembling the two devices with one another and of locking them in the assembled position, the marking device and/or the complementary device including the means of attachment to the item or to the packaging thereof.

3. The protection assembly as claimed in claim 1, characterized in that the information support is a support including a plurality of printed information regions, the information selection means being able to select one or more information regions to be viewed in the viewing zone, the other information regions being hidden.

4. The protection assembly as claimed in claim 1, characterized in that the marking device includes an information display window where at least part of the window is transparent and constitutes the information viewing zone so that the selected information region or regions is or are visible through the at least one transparent window part.

5. The protection assembly as claimed in claim 4, characterized in that the support is an elongate strip including a plurality of printed information regions arranged side by side in the lengthwise direction of the strip, the strip being wound around two rollers which are spaced apart and each capable of rotating about their longitudinal axis in order to cause information regions of the strip to file past the at least one transparent window part.

6. The protection assembly as claimed in claim 5, characterized in that the turning of the rollers is brought about by a tool external to the marking device.

7. The protection assembly as claimed in claim 6, characterized in that the tool is an electric screwdriver which may or may not be fitted with a torque control mechanism.

8. The protection assembly as claimed in claim 6, characterized in that the tool is a manual screwdriver, the marking device including a torque control mechanism between the tool and one of the rollers to be actuated.

9. The protection assembly as claimed in claim 5, characterized in that the marking device includes:
at least one motor connected to at least one of the rollers by a gearing mechanism,
at least one electrical power supply system,
at least one electrical control system for controlling the at least one motor,
at least one activation information receiver element for controlling the at least one motor.

10. The protection assembly as claimed in claim 4, characterized in that the support is a disk including on one face a plurality of printed information regions arranged side by side over various angular sectors of the face of the disk.

11. The protection assembly as claimed in claim 10, characterized in that the disk or the window is able to rotate about its center to bring information regions and the at least one transparent window part geometrically into register with one another.

12. The protection assembly as claimed in claim 10, characterized in that a cover is positioned on top of the disk and is provided with an opening positioned facing an information region that is to be viewed.

13. The protection assembly as claimed in claim 12, characterized in that the cover is able to turn about its center so that the opening is brought geometrically into register with an information region that is to be viewed.

14. The protection assembly as claimed in claim 1, characterized in that the information viewing zone is a digital display screen, the marking device including:
at least one power supply system,
at least one display selection system,
at least one activation-information receiver element for selecting the display.

15. The protection assembly as claimed in claim 1, characterized in that the marking device includes a spike extending out from it and collaborating with the complementary device so that the two devices can be assembled and locked together.

16. The protection assembly as claimed in claim 4, characterized in that the marking device includes a casing forming an open housing to accommodate the information support, the display window being positioned on the casing in such a way as to close the housing.

17. The protection assembly as claimed in claim 15, characterized in that the marking device includes an information display window where at least part of the window is transparent and constitutes the information viewing zone, and the spike extends out from the casing in the direction away from the window.

18. The protection assembly as claimed in claim 4, characterized in that the window is arranged via one of its faces referred to as the internal face facing a face referred to as the internal face of the information support bearing the information regions, a spike attached to the window extending from the internal face of the window toward the internal face of the support and passing through the latter so that it protrudes to the outside with respect to a face referred to as the external face of the support.

19. The protection assembly as claimed in claim 4, characterized in that the marking device includes a head having two opposite faces, an internal face and an external face from which the spike extends, the information support being positioned between the internal face of the head and the display window.

20. The protection assembly as claimed in claim 16, characterized in that the marking device includes locking means for locking a spike that is intended to be introduced into the casing.

21. The protection assembly as claimed in claim 1, characterized in that the marking device and/or the complementary device includes at least one active or passive member which is able to emit electromagnetic waves to outside the device or to receive such waves.

22. An item equipped with an assembly for protecting it against theft as claimed in claim 1.
